(19) United States
(12) Patent Application Publication
(10) Pub. No.: US 2014/0311682 A1
(43) Pub. Date: Oct. 23, 2014

(54) BEAD BREAKING UNIT FOR TYRE CHANGING MACHINES OR THE LIKE

(71) Applicant: GIULIANO GROUP S.p.A., Correggio (RE) (IT)

(72) Inventor: Maurizio BONACINI, Correggio (RE) (IT)

(73) Assignee: GIULIANO GROUP S.p.A., Correggio (RE) (IT)

(21) Appl. No.: 14/223,193

(22) Filed: Mar. 24, 2014

(30) Foreign Application Priority Data
Apr. 23, 2013 (IT) MO2013A000110

(51) Int. Cl. B60C 25/13

(52) U.S. Cl. CPC B60C 25/13
USPC 157/1.24

(57) ABSTRACT

The bead breaking unit (1) for tyre changing machines includes an arm (2) associated revolving with a supporting structure (3), a bead breaking tool (4) associated with the arm (2), at least a movement device (6) operatively associated with the arm (2) and suitable for moving the arm (2) from a disengaging position, wherein the bead breaking tool (4) is substantially moved away from a tyre of a wheel to undergo bead breaking, to an operating position, wherein the bead breaking tool (4) is suitable for engaging on the tyre, the arm (2) having at least a tilting device (7) of the bead breaking tool (4) suitable for allowing the partial rotation of the bead breaking tool (4) when it is engaged on the tyre, an adjustment arrangement (11) for adjusting the angular position of the bead breaking tool (4) and at least an activation/deactivation device (12) of the tilting device (7).

### BACKGROUND OF THE INVENTION

The present invention relates to a bead breaking unit for tyre changing machines

### DESCRIPTION OF THE RELATED ART

Tyre changing machines are commonly used for fitting/removing vehicle wheel tyres to/from respective rims.

As is known, before being able to completely remove a tyre from its housing on the respective rim, it is necessary to detach the beads thereof from the bead retention edges on the rim itself.

This operation is performed by means of a suitable bead breaking unit, normally present on the tyre changing machine itself.

Bead breaking units of known type comprise an arm with a first extremity hinged to the bed of the tyre changing machine according to a substantially vertical axis and a second extremity having a bead breaking tool, otherwise known as blade.

On the bed is fastened a resting element, usable to correctly fit the rim during the bead breaking operation.

This resting element has a resting surface, otherwise known as pad, which is made of suitable material, and usually knurled in such a way as to increase the friction coefficient with the wheel.

The bead breaking units of known type generally comprise a linear actuator of the type, e.g., of a fluid actuator cylinder for moving the arm.

During use, an operator suitably positions the portion of the wheel to undergo bead breaking in correspondence to the pad and positions the blade in contact with a section of the tyre bead.

Subsequently, the operator starts the actuator cylinder and the blade pushes the tyre bead, detaching it from the rim edge.

Subsequently, the blade inserted between tyre and rim is extracted.

Bead breaking units are also known having a suitable device for positioning the bead breaking blade on two or more predefined angular positions with respect to the bead resting surface.

In particular, the inclination of the blade can be set according to the particular type of tyre to undergo bead breaking.

Generally, in fact, the need is felt to vary the inclination of the blade according to the hardness of the tyre to undergo bead breaking.

In particular, for a wheel with a harder tyre, it could be convenient to set a reduced angle of incidence (generally close to 21°, so as to apply a pressure along a narrower and more defined portion of the tyre, in the proximity of the edge of the rim.

For a wheel with a softer tyre, on the other hand, it could be convenient to set a greater angle of incidence (generally close to 27°, so as to apply a pressure along a wider portion of the tyre to favour detachment from the rim edge while stressing the tyre as little as possible.

Bead breaking units are in fact known with an operating head having two different blades, arranged with different angular positions, wherein the operating head can be rotated to position each of the two blades alternately in the work position.

The use is also known of bead breaking units having a tilting blade, suitable for varying its inclination, in contrast to the action of one or more springs, during the pressure applied on a tyre.

In particular, such tilting makes it easier to fit the blade between the tyre bead and the edge of the rim.

Generally speaking, in case of need, such tilting can be locked by means of a suitable pin lock.

Nevertheless, the bead breaking units of known type are susceptible to upgrading, aimed in particular at achieving an optimum bead breaking according to the particular type of tyre to undergo bead breaking.

### SUMMARY OF THE INVENTION

The main aim of the present invention is to provide a bead breaking unit for tyre changing machines or the like which allows an optimum bead breaking depending on the particular type of tyre to undergo bead breaking.

Another object of the present invention is to provide a bead breaking unit for tyre changing machines which permits a simpler and faster adjustment of blade inclination and/or tilting.

Another object of the present invention is to provide a bead breaking unit for tyre changing machines which allows overcoming the mentioned drawbacks of the state of the art within the ambit of a simple, rational, easy and effective to use as well as low cost solution.

The above objects are achieved by the present bead breaking unit for tyre changing machines, comprising at least one arm associated revolving with a supporting structure, at least a bead breaking tool associated with said arm, at least a movement device operatively associated with said arm and suitable for moving said arm from a disengaging position, wherein said bead breaking tool is substantially moved away from a tyre of a wheel to undergo bead breaking, to an operating position, wherein said bead breaking tool is suitable for engaging on said tyre, said arm having at least a tilting device of said bead breaking tool suitable for allowing the partial rotation of said bead breaking tool when it is engaged on said tyre, an adjustment arrangement for adjusting the angular position of said bead breaking tool and at least an activation/deactivation device of said tilting device.

### BRIEF DESCRIPTION OF THE DRAWINGS

Other characteristics and advantages of the present invention will become more evident from the description of a preferred, but not sole, embodiment of a bead breaking unit for tyre changing machines, illustrated purely as an example but not limited to the annexed drawings in which:

FIG. 1 is an axonometric view of the bead breaking unit according to the invention fitted on a conventional tyre changing machine;

FIG. 2 is a top view of the bead breaking unit according to the invention with the bead breaking tool in a first predefined angular position;

FIG. 3 is an axonometric view of the bead breaking unit according to the invention with the bead breaking tool in a first predefined angular position;

FIG. 4 is a top view of the bead breaking unit according to the invention with the bead breaking tool in a second predefined angular position;

FIG. 5 is an axonometric view of the bead breaking unit according to the invention with the bead breaking tool in a second predefined angular position;

FIG. 6 is a top view showing different tilting positions of the bead breaking unit according to the invention;

FIG. 7 is an axonometric view showing the bead breaking unit according to the invention in an idle position;

FIG. 8 is an axonometric view showing the bead breaking unit according to the invention in a tilted position due to the action of the tilting device;

FIG. 9 is a top view of the bead breaking unit according to the invention with the tilting device deactivated;

FIG. 10 is an axonometric view of the bead breaking unit according to the invention with the tilting device deactivated;

FIG. 11 is a top view of the lower plate of the supporting element of the bead breaking unit according to the invention.

### DESCRIPTION OF THE PREFERRED EMBODIMENTS

With particular reference to such figures, globally indicated by 1 is a bead breaking unit which can be fitted on tyre changing machines of known type and usable for the first detachment of the bead of the tyre from the respective rim of a wheel, before the fitting/removing operation of the tyre itself.

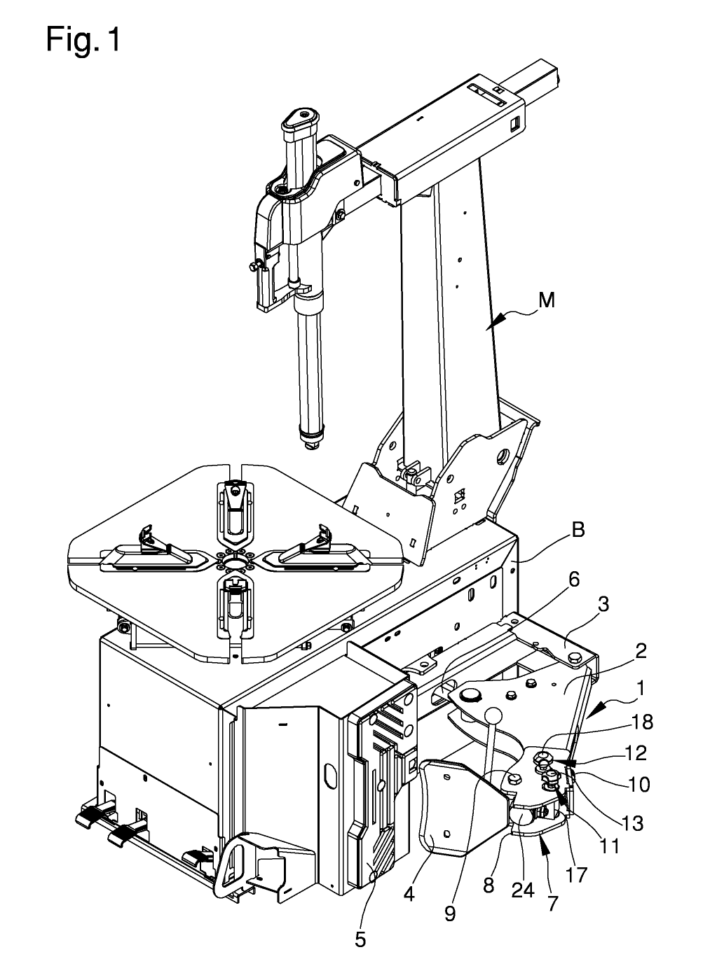

The bead breaking unit 1 can be fitted e.g. on a conventional tyre changing machine M of the type shown in FIG. 1.

The bead breaking unit 1 comprises an arm 2 with a first extremity hinged to a supporting structure 3 and revolving around a substantially vertical hinging axis, and a second extremity having a bead breaking tool 4.

The bead breaking tool 4 can be composed, e.g., of a conventional bead breaking blade.

The supporting structure 3 can be fixed, e.g., to the bed B of the tyre changing machine M.

To the bed B is fixed a suitable resting surface 5, otherwise called pad, usable for the correct positioning of a wheel to undergo bead breaking.

The arm 2 is suitable for oscillating between a disengaging position, wherein the blade 4 is substantially spaced apart from the resting surface 5, and an operating position, wherein the blade 4 is placed substantially close to the resting surface 5 and is suitable for engaging on one side of the tyre of a wheel to undergo bead breaking.

The bead breaking unit 1 also comprises a movement device 6, composed e.g. of a linear actuator, operatively associated with the arm 2 and suitable for moving it from the disengaging position to the operating position.

The bead breaking unit 1 also has a tilting device for tilting the blade 4, altogether indicated in the illustrations by the reference 7, suitable for allowing the partial rotation of the blade 4 when this is engaged on the tyre.

In practice, such tilting makes it easier to fit the blade 4 between the tyre bead and the edge of the rim.

In particular, the tilting device 7 comprises a sustaining element 8 which supports the blade 4 and which is associated with the free extremity of the arm 2 revolving around a tilting axis X.

With particular reference to the embodiment of the bead breaking unit 1 shown in the illustrations, the sustaining element 8 is composed of a pair of integral plates, parallel and distanced from each other, hinged at the free extremity of the arm 2 by means of a pin 9, in correspondence to the tilting axis X.

The tilting device 7 also comprises at least a flexible element 10, preferably composed of a spring, placed between a portion of the sustaining element 8 and a portion of the arm 2 and suitable for operating in contrast to the rotation of the sustaining element itself when the blade 4 is engaged and applies a pressure on the side of a tyre to undergo bead breaking.

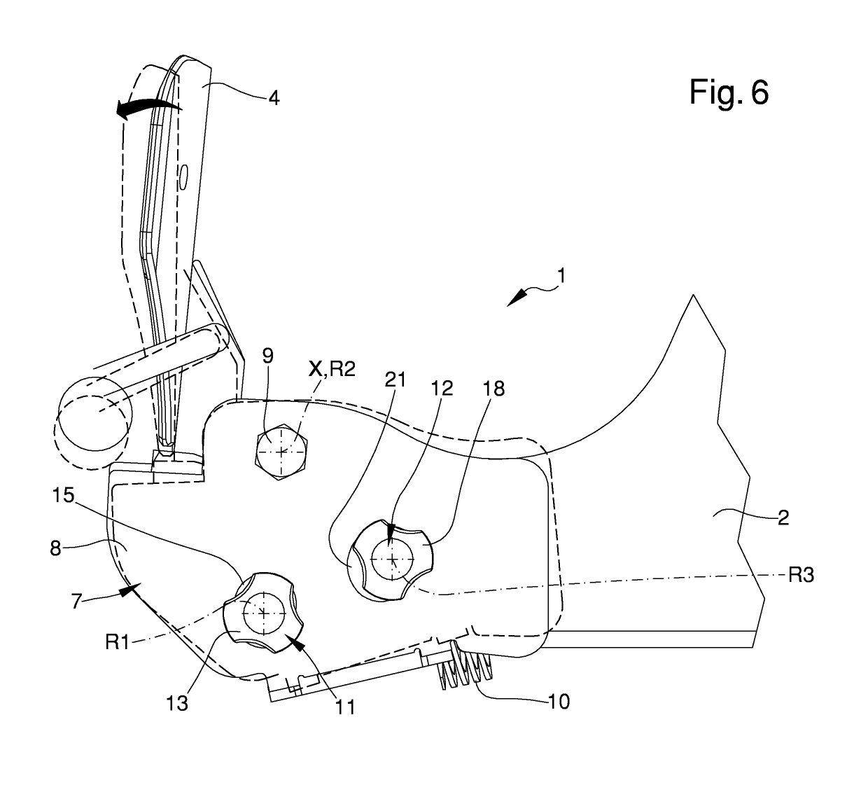

The partial rotation of the sustaining element 8 in contrast to the spring 10 is shown by way of example in the FIG. 6.

Advantageously, the bead breaking unit 1 comprises an adjustment arrangement 11 suitable for adjusting the angular position of the blade 4 and an activation/deactivation device 12 suitable for activating/deactivating the tilting device 7.

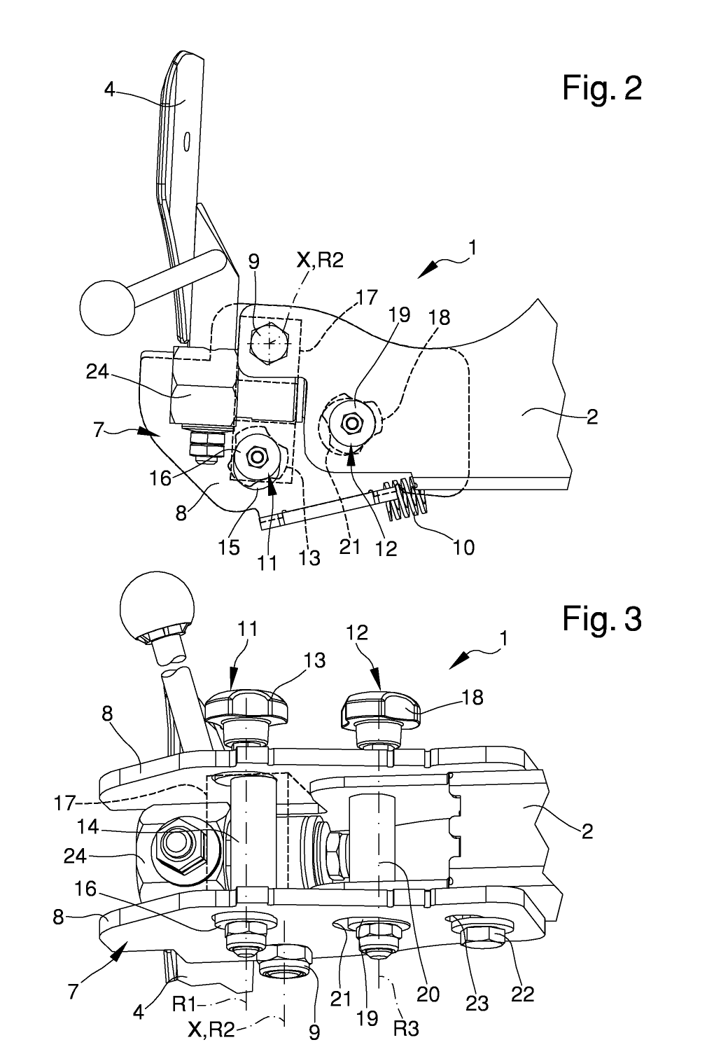

In particular, the adjustment of the angular position of the blade 4 and the activation/deactivation of tilting can be carried out according to the dimensions and/or the hardness and/or the particular type of tyre to undergo bead breaking. In particular, for a wheel with a soft tyre, it could be convenient to set a greater angle of incidence (generally close to 27°, so as to apply a pressure along a more ample portion of the tyre and to favour its detachment from the edge of the rim, thereby stressing the tyre as little as possible (FIGS. 2 and 3).

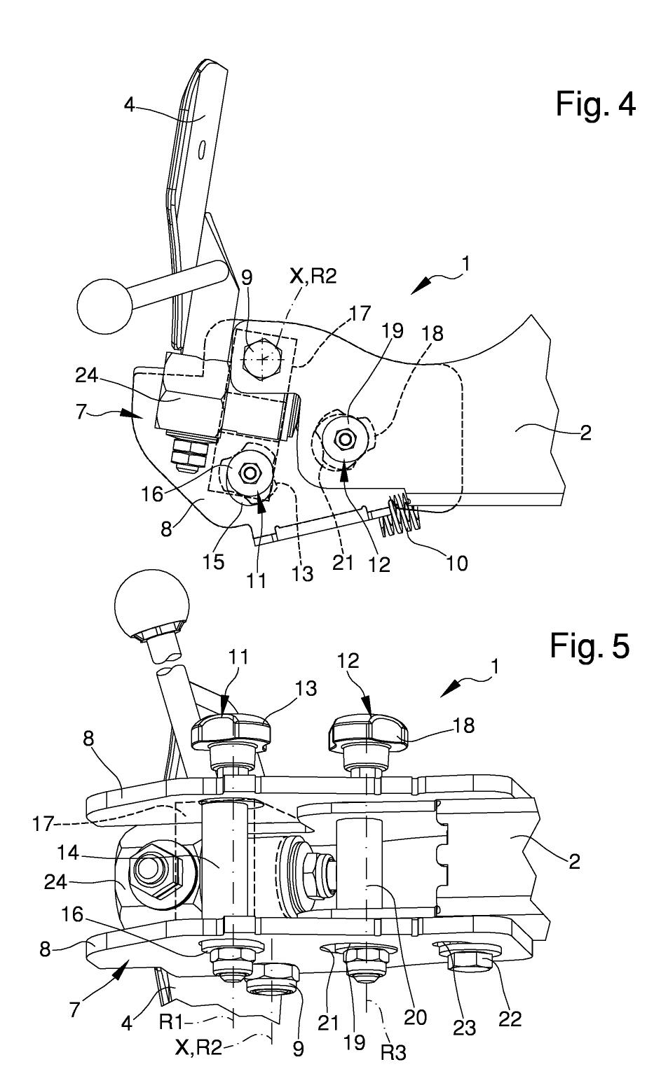

For a wheel with a harder tyre, instead, it might be convenient to set a reduced angle of incidence (generally close to 21°, so as to apply a pressure along a narrower and more defined portion of the tyre, in the proximity of the edge of the rim (FIGS. 4 and 5).

This permits performing optimum bead breaking in accordance with the particular type of tyre to undergo bead breaking.

In particular, the adjustment arrangement 11 is suitable for varying the angle of incidence of the blade 4 with respect to the resting surface 5.

With reference to the particular embodiment of the bead breaking unit 1 shown in the illustrations, the adjustment arrangement 11 comprises a first operating element 13, having a grip, operatively associated with the blade 4 and which can be operated to vary the angular position of the blade itself.

The first operating element 13 can consist, e.g., of a first grip knob.

The first knob 13 is associated revolving around the sustaining element 8 and the adjustment arrangement 11 comprises a transformation arrangement for transforming the rotary motion of the first knob 13 into a rotary motion of the blade 4.

For example, such means of transformation comprise a first eccentric element 14 having the first knob 13 and revolving around a first rotation axis R1.

In particular, with reference to the preferred but not sole embodiment shown in the illustrations, the transformation arrangement of the rotary motion of the first knob 13 into the rotary motion of the blade 4 are composed of a crank mechanism, where the first eccentric element 14 is composed of a first pin which extends between the plates of the sustaining element 8.

The first pin 14, besides being eccentric and revolving around the first rotation axis R1, is associated translatable with the sustaining element 8 along at least one direction of translation.

In particular, the sustaining element 8 has guide 15 suitable for guiding the first pin 14 along a direction of translation.

In particular, the guide 15 is composed of a pair of first elongated slots made in correspondence to respective portions of each of the plates of the sustaining element 8.

Inside each of the first slots 15, respective first crank arm supports 16 of the first pin 14 are housed.

In particular, the first knob 13 is fastened to the first support 16 associated with the upper plate of the sustaining element 8.

A supporting element 17 of the blade 4, with a substantially elongated shape, has a first extremity associated revolving with the arm 2, in correspondence to a second rotation axis R2, and a second extremity having a housing suitable for housing the first pin 14 to measure and rotatable.

Consequently, the rotation of the first knob 13 involves the rotation of the first pin 14 around the first rotation axis R1 and, at the same time, the translation of the first supports 16 inside the respective first slots 15, thereby allowing the adjustment of the angular position of the supporting element 17 and, consequently, the adjustment of the angular position of the blade 4.

By way of example, in the FIGS. 2 and 3 and in the FIGS. 4 and 5 two possible predefined extreme angular positions of the blade 4 are shown respectively.

Usefully, the activation/deactivation device 12 comprises a second operating element 18 operatively associated with the tilting device 7 and which can be operated to activate/deactivate the tilting device itself.

Preferably, the second operating element 18 is composed of a second grip knob. In particular, the activation/deactivation device 12 comprises at least a second eccentric element 19 having a second knob 18, revolving around a third rotation axis R3 between a release position, wherein the tilting device 7 is activated, and a locking position, wherein the tilting device 7 is deactivated.

Consequently, with the second eccentric element 19 in the release position, the rotation of the sustaining element 8 is allowed in contrast to the spring 10, while with the second eccentric element 19 in locking position, the free rotation is prevented of the sustaining element 8 which is therefore fixed and integral with respect to the arm 2.

In particular, when it is in the locking position, the second eccentric element 19 is suitable for engaging in correspondence to a respective reference portion of the sustaining element 8 to prevent the sustaining element itself from rotating free around the tilting axis X.

In particular, with reference not only to the preferred embodiment shown in the illustrations, the activation/deactivation device 12 is composed of a crank mechanism, where the second eccentric element 19 is composed of a pair of second supports suitable for supporting, in correspondence to the opposite extremities, a second pin 20 which extends between the plates of the sustaining element 8.

The second pin 20 is axially revolving around the third rotation axis R3 and the second supports 19 are housed inside the respective second slots 21 made in correspondence to respective portions on each of the plates of the sustaining element 8.

The second knob 18 is fastened to the second support 19 associated with the upper plate of the sustaining element 8.

When, by means of the rotation of the second knob 18, the second supports 19 are rotated and arranged in the locking position, each of them is suitable for engaging in correspondence to a respective section of the inner edge of each of the slots 21, to prevent the sustaining element 8 from rotating free around the tilting axis X.

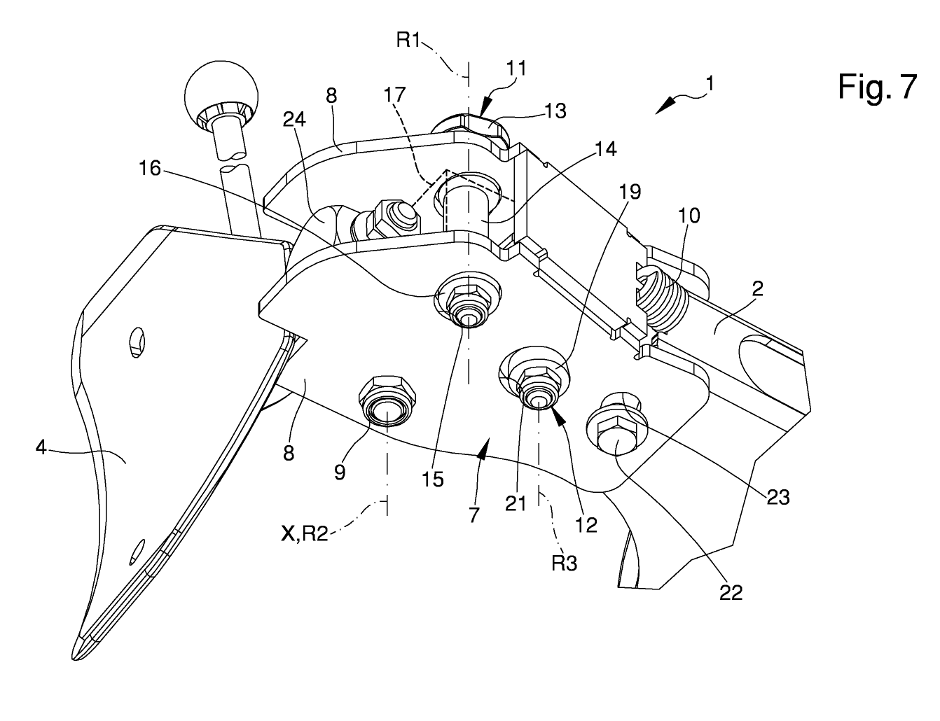

In particular, the FIG. 7 shows the bead breaking unit 1 in an idle position, with the activation/deactivation device 12 in the release position.

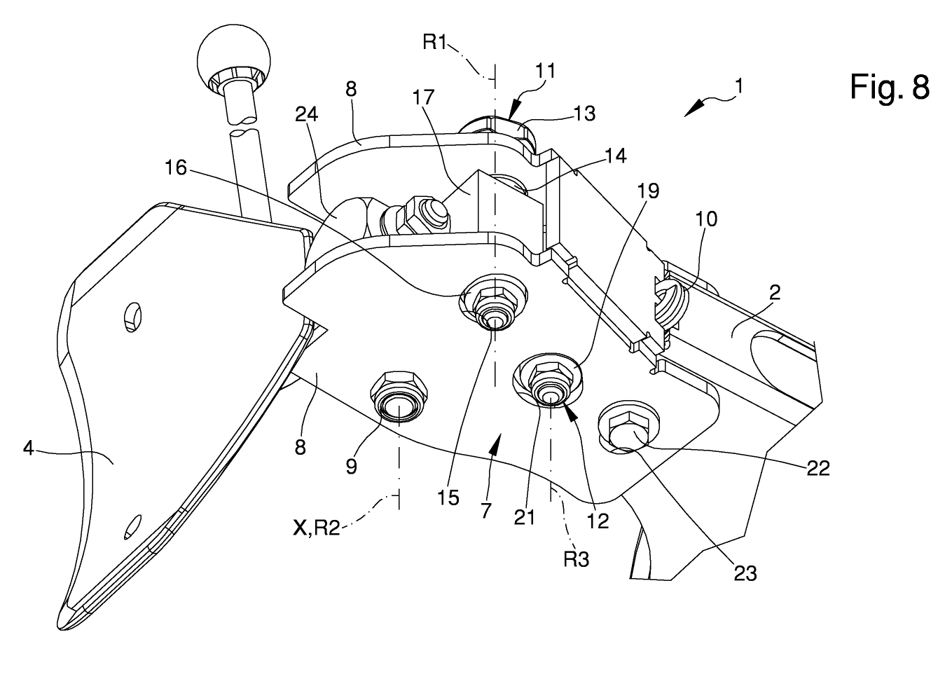

The FIG. 8 instead shows the bead breaking unit 1 in a tilted position due to the action of the tilting device, with the activation/deactivation device 12 in the release position.

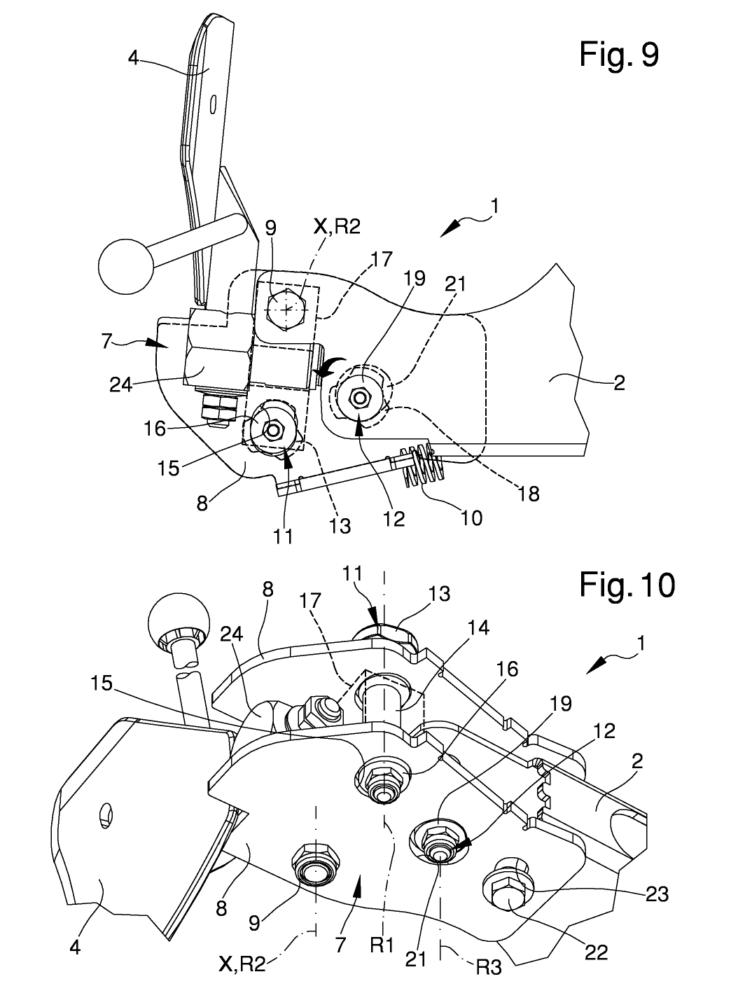

Furthermore, the FIGS. 9 and 10 show the bead breaking unit 1 with the activation/deactivation device 12 in the locking position.

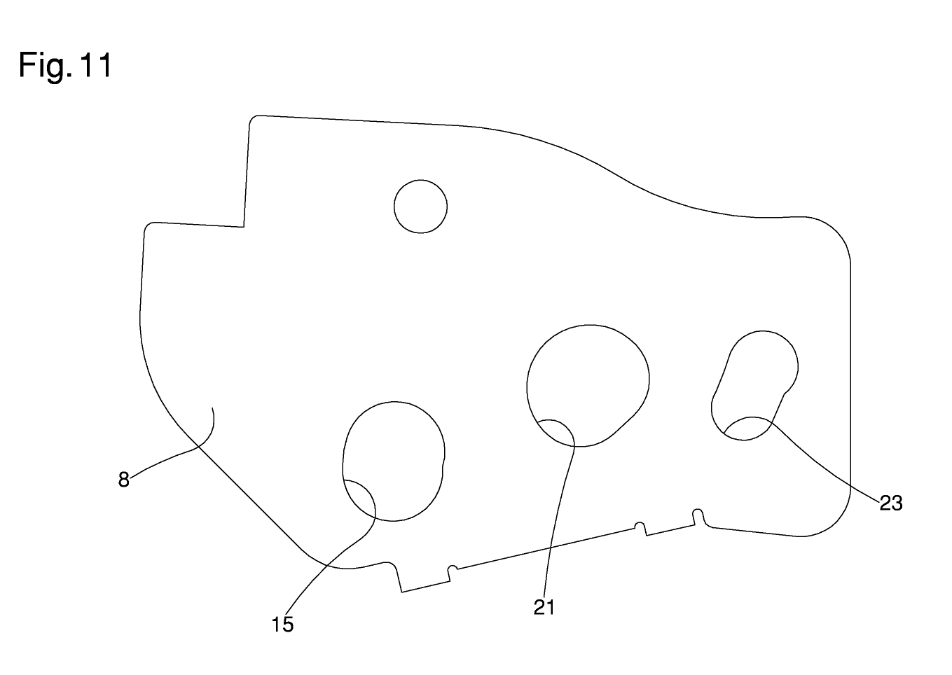

By way of example, the FIG. 11 shows, in detail, possible and preferred conformations of the first, the second and the third slots 15, 21 and 23 made on the plates of the sustaining element 8.

Usefully, the stroke of the sustaining element 8 during the rotation around the tilting axis X is restricted by the action of a third pin 22, fastened in correspondence to a lower portion of the arm 2, fitted sliding inside a third slot 23, elongated and curvilinear, made along a portion of the lower plate of the sustaining element 8, and suitable for engaging in correspondence to the edges of the opposite extremities of the third slot 23.

Usefully, the bead breaking unit 1 has at least a joint 24, placed between the supporting element 17 and the blade 4, suitable for permitting further variations of the orientation of the blade itself.

It has in practice been ascertained how the described invention achieves the proposed objects.

1) Bead breaking unit (1) for tyre changing machines, comprising at least one arm (2) associated revolving with a supporting structure (3), at least a bead breaking tool (4) associated with said arm (2), at least a movement device (6) operatively associated with said arm (2) and suitable for moving said arm (2) from a disengaging position, wherein said bead breaking tool (4) is substantially moved away from a tyre of a wheel to undergo bead breaking, to an operating position, wherein said bead breaking tool (4) is suitable for engaging on said tyre, said arm (2) having at least a tilting device (7) of said bead breaking tool (4) suitable for allowing the partial rotation of said bead breaking tool (4) when it is engaged on said tyre, an adjustment arrangement (11) for adjusting the angular position of said bead breaking tool (4) and at least an activation/deactivation device (12) of said tilting device (7).

2) Bead breaking unit (1) according to claim 1, comprising at least one resting surface (5) of said tyre to undergo bead breaking, said adjustment arrangement (11) being suitable for varying the angle of incidence of said bead breaking tool (4) with respect to said resting surface (5).

3) Bead breaking unit (1) according to claim 1, wherein said adjustment arrangement (11) comprises at least a first operating element (13) operatively associated with said bead breaking tool (4) and which can be operated to vary the angular position of said bead breaking tool (4).

4) Bead breaking unit (1) according to the claim 3, wherein said first operating element (13) is associated revolving with said arm (2) and said adjustments arrangement (11) comprise a transformation arrangement (14, 15, 16, 17) for transforming the rotary motion of said operating element into a rotary motion of said bead breaking tool (4).

5) Bead breaking unit (1) according to claim 4, wherein said transformation arrangement (14, 15, 16, 17) comprises at least a first eccentric element (14) having said first operating element (13) and revolving around a first rotation axis (R1).

6) Bead breaking unit (1) according to claim 5, wherein said transformation arrangement (14, 15, 16, 17) comprises at least a supporting element (17) of said bead breaking tool (4), with a substantially elongated shape, with a first extremity associated revolving with said arm (2) in correspondence to a second rotation axis and with a second extremity having a housing suitable for housing rotatable said first eccentric element (14).

7) Bead breaking unit (1) according to claim 5, wherein said first eccentric element (14) is associated translatable with said arm (2) along at least a direction of translation.

8) Bead breaking unit (1) according to claim 7, comprising at least a guide (15) for guiding the translation of said first eccentric element (14) along said direction of translation.

9) Bead breaking unit (1) according to claim 1, wherein said tilting device (7) comprises at least a flexible element (10) placed between said bead breaking tool (4) and said arm (2) and suitable for operating in contrast to the rotation of said bead breaking tool (4) when it is engaged on said tyre.

10) Bead breaking unit (1) according to claim 1, wherein said activation/deactivation device (12) comprises at least a second operating element (18) operatively associated with said tilting device (7) and which can be operated to activate/deactivate said tilting device (7).

11) Bead breaking unit (1) according to claim 10, wherein said activation/deactivation device (12) comprises at least a second eccentric element (19) having said second operating element (18), revolving around a third rotation axis (R3) between a release position, wherein said tilting device (7) are activated, and a locking position, wherein said tilting device (7) is deactivated.

12) Bead breaking unit (1) according to claim 11, wherein said tilting device (7) comprises at least a sustaining element (8) revolving around a tilting axis (X) and suitable for sustaining said bead breaking tool (4) and in that, when positioned in said locking position, said second eccentric element (19) is suitable for engaging in correspondence to a respective reference portion of said sustaining element (8) to prevent said sustaining element (8) from rotating free around said tilting axis (X).

13) Bead breaking unit (1) according to claim 12, wherein said sustaining element (8) comprises at least an elongated slot (21) for housing said second eccentric element (19), said reference portion being made up of at least a section of the inner edge of said elongated slot.
